(19) United States
(12) Patent Application Publication
(10) Pub. No.: US 2025/0073597 A1
(43) Pub. Date: Mar. 6, 2025

(54) Method And Device For Detecting Multi-Access Account By Using Similarity Degree Between Nicknames

(71) Applicant: Kakao Games Corp., Gyeonggi-do (KR)

(72) Inventor: Daesub SONG, Gyeonggi-do (KR)

(73) Assignee: Kakao Games Corp., Gyeonggi-do (KR)

(21) Appl. No.: 18/292,702

(22) PCT Filed: Apr. 18, 2023
(86) PCT No.: PCT/KR2023/005200

§ 371 Date: Jan. 26, 2024

(30) Foreign Application Priority Data
Mar. 17, 2022 (KR) 10-2022-0064863

(51) Int. Cl. A63F 13/75; G06F 40/20

(52) U.S. Cl. CPC A63F 13/75; G06F 40/20

(57) ABSTRACT

Disclosed is a method for detecting a multi-access account using a similarity between nicknames, which is performed by a computing device. The method may include: acquiring a plurality of component information from a plurality of nickname information based on predetermined configuration unit information; generating a nickname matrix using the plurality of component information; determining a similarity between nickname information using the nickname matrix; and determining a similar nickname group using the similarity.

### CROSS-REFERENCE TO RELATED APPLICATIONS

This application claims priority to and the benefit of Korean Patent Application No. 10-2022-0064863 filed in the Korean Intellectual Property Office on May 26, 2022, the entire contents of which are incorporated herein by reference.

### TECHNICAL FIELD

The present disclosure relates to a computer technology field, and more particularly, to a method and a device for detecting a multi-access account using a similarity between nicknames.

### BACKGROUND ART

‘Workplace’, which enterprisingly collects and sells game items, has begun to prevail as the size of cash transactions grew in the PC MMORPG in the late 90s to the early 2000s. They encourage in-game inflation to disturb the game economy, allowing ordinary users to feel deprived. Game companies have no choice but to assign separate management personnel to catch the users, which will not be able to concentrate on the content development and service enhancement, causing the quality of the game to be deteriorated.

In PC online games, dozens of PCs, spaces, and separate auto programs for the operation of the workplace are required, but most mobile games officially supported automatic combat functions and smaller in places and equipment, so there are also cases where individuals, not organizations, run the workplace. Mobile game workplaces are smaller and often do not use programs that can be recognized by game companies, so the mobile game workplaces are more difficult to uncover than online game workplaces. Mobile MMORPG game companies are taking several ways to eradicate illegal workplaces for stable game services.

The classic method is to uncover and stop a workplace account through continuous monitoring. Most games are sanctioned with workplace suspicion accounts in this way. In past PC online game years, it was possible to track only traces of non-authentic auto program use, but a workplace using only an automatic combat function and some basic macro programs basically installed in the game without such illegal programs require a more cumbersome process. For example, such a scheme is a scheme in which by a method of preferentially selecting a case where too many accounts are connected or produced in one IP, and then reviewing the case in detail, a workplace account is found. However, this scheme requires a lot of time and money. Thus, there is a demand for technology to simplify this process.

### SUMMARY OF THE INVENTION

The present disclosure is contrived in response to the above-mentioned background art, and has been made in an effort to provide a method and a device for detecting a multi-access account using a similarity between nicknames.

An exemplary embodiment of the present disclosure provides a method for detecting a multi-access account using a similarity between nicknames, which is performed by a computing device. The method may include: acquiring a plurality of component information from a plurality of nickname information based on predetermined configuration unit information; generating a nickname matrix using the plurality of component information; determining a similarity between nickname information using the nickname matrix; and determining a similar nickname group using the similarity.

Alternatively, the nickname matrix may include a plurality of vector information corresponding to the plurality of component information, respectively, and the similarity may be determined by a Jaccard Distance between two vector information corresponding to two nickname information.

Alternatively, the component information may define existence or non-existence of a component included in the predetermined configuration unit information in corresponding nickname information.

Alternatively, the predetermined configuration unit information may include Korean vowels and consonants.

Alternatively, the predetermined configuration unit information may include English alphabet.

Alternatively, the predetermined configuration unit information may include Arabic numbers.

Another exemplary embodiment of the present disclosure provides a computing device for performing a method for detecting a multi-access account using a similarity between nicknames. The device may include: a processor including at least one core; and a memory including program codes executable in the processor, and wherein the processor may be configured to acquire a plurality of component information from a plurality of nickname information based on predetermined configuration unit information, generate a nickname matrix using the plurality of component information, determine a similarity between nickname information using the nickname matrix, and determine a similar nickname group using the similarity.

Still another exemplary embodiment of the present disclosure provides a computer program stored in a computer-readable storage medium. When the computer program is executed by one or more processors, the computer program may allow one or more processors to perform operations for performing a method for detecting a multi-access account using a similarity between nicknames, and the method may include: acquiring a plurality of component information from a plurality of nickname information based on predetermined configuration unit information; generating a nickname matrix using the plurality of component information; determining a similarity between nickname information using the nickname matrix; and determining a similar nickname group using the similarity.

According to an exemplary embodiment of the present disclosure, a method and a device for detecting a multi-access account using a similarity between nicknames can be provided.

### BRIEF DESCRIPTION OF THE DRAWINGS

FIG. 1 is a block diagram of a computing device for performing a method for detecting a multi-access account using a similarity between nicknames according to some exemplary embodiment of the present disclosure.

FIG. 2 is a diagram for describing a process of acquiring a plurality of component information from a plurality of nickname information according to some exemplary embodiments of the present disclosure.

FIG. 3 is a diagram for describing a process of generating a nickname matrix using the plurality of component information according to some exemplary embodiments of the present disclosure.

FIG. 4 is a diagram for describing a process of determining a similarity between nickname information using the nickname matrix according to some exemplary embodiments of the present disclosure.

FIG. 5 is a flowchart of a method for detecting a multi-access account using a similarity between nicknames according to some exemplary embodiment of the present disclosure.

FIG. 6 is a simple and normal schematic view of an exemplary computing environment in which some exemplary embodiments of the present disclosure may be implemented.

### DETAILED DESCRIPTION

Various exemplary embodiments are described with reference to the drawings. In the present specification, various descriptions are presented for understanding the present disclosure.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

A term “or” intends to mean comprehensive “or”, not exclusive “or”. That is, unless otherwise specified or when it is unclear in context, “X uses A or B” intends to mean one of the natural comprehensive substitutions. That is, when X uses A, X uses B, or X uses both A and B, or “X uses A or B” may be applied to any one among the cases. Further, a term “and/or” used in the present specification shall be understood to designate and include all of the possible combinations of one or more items among the listed relevant items.

It should be understood that a term “include” and/or “including” means that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear in context that a single form is indicated, the singular shall be construed to generally mean “one or more” in the present specification and the claims.

The term “at least one of A and B” should be interpreted to mean “the case including only A”, “the case including only B”, and “the case where A and B are combined”

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, such implementation decisions should not be interpreted as causing a departure from the scope of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

According to some exemplary embodiments of the present disclosure, the present disclosure can provide a method and a device for detecting a multi-access account using a similarity between nicknames. ‘Workplace’, which collects and sells game items enterprisingly, uses a number of multi-access accounts. Multiple workplace accounts are rapidly generated as an online game becomes successful, and the investigation and sanction of the workplace account takes a long time, and another workplace continues to be generated. In addition, the workplace accounts use IP bypass, virtual VMs, and various hardware bypass tools, so it is difficult to uncover. One feature of the workplace account is that the nicknames of the characters managed by a workplace are generally similar. Therefore, it may be possible to identify the workplace account by visually identifying the nicknames of similar characters. However, thousands of connection accounts are created in an hour, and even at dawn, the connection account that cannot be identified by the naked eye may be created. If a new server is opened, there may be several times more user accounts, and some workplaces may be at the same time on various servers. The method and device to detect multi-access accounts using the similarity between nicknames according to some exemplary embodiments of the present disclosure may quickly determine the similar nickname group suspected of a multi-access account. According to some exemplary embodiments of the present disclosure, a first similar nickname group can be quickly determined, which can significantly reduce the time and resource necessary in the process of finding the workplace account. Hereinafter, a method and a device for detecting a multi-access account using a similarity between nicknames according to some exemplary embodiment of the present disclosure will be described with reference to drawings.

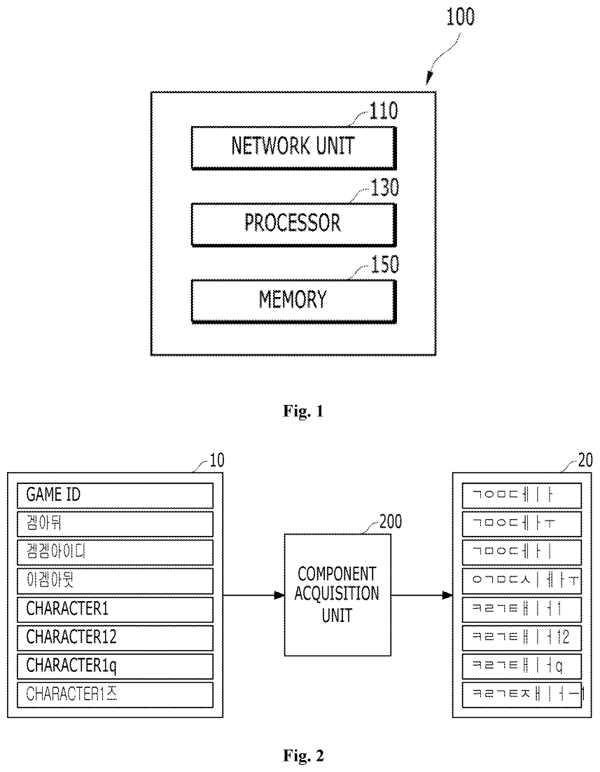

FIG. 1 is a block diagram of a computing device for performing a method for detecting a multi-access account using a similarity between nicknames according to some exemplary embodiment of the present disclosure.

As illustrated in FIG. 1, the computing device 100 may include a processor 110, a memory 130, and a network unit 150. A configuration of the computing device 100 illustrated in FIG. 1 is only an example shown through simplification. In some exemplary embodiments of the present disclosure, the computing device 100 may include other components for performing a computing configuration of the computing device 100 and only some of the disclosed components may constitute the computing device 100.

The processor 110 may be constituted by one or more cores and may include processors for data analysis and processing, which include a central processing unit (CPU), a general purpose graphics processing unit (GPGPU), a tensor processing unit (TPU), and the like of the computing device. The processor 110 may read a computer program stored in the memory 130 to perform data conversion, operation, generation, etc., for performing a method for detecting a multi-access account using a similarity between nicknames according to some exemplary embodiments of the present disclosure.

According to some exemplary embodiments of the present disclosure, the processor 110 may perform steps for performing the method for detecting a multi-access account using a similarity between nicknames described below. For example, the processor 110 may acquire a plurality of component information from a plurality of nickname information based on a predetermined configuration unit information. The processor 110 may generate a nickname matrix using the plurality of component information. The processor 110 may determine the similarity between the nickname information using the nickname matrix. The processor 110 may determine a similar nickname group using the similarity. However, the present disclosure is not limited thereto, and the processor 110 may perform various steps for performing the method for detecting the multi-access account using the similarity between the nicknames.

The processor 110 may implement various units and modules for performing the method for detecting the multi-access account using the similarity between the nicknames. For example, hereinafter, as described with reference to FIGS. 2 to 4, the processor 110 may implement a component acquisition unit 200, a matrix generation unit 300, a similarity determination unit 400, and operations thereof. The component acquisition unit 200, the matrix generation unit 300, and the similarity determination unit 400 may be implemented to perform various operations implemented with general computer technology in addition to the operations described herein.

According to some exemplary embodiments of the present disclosure, the memory 130 may store any type of information generated or determined by the processor 110 or any type of information received by the network unit 150. For example, the memory 130 may store data generated in the process of detecting the multi-access account using the similarity between the nicknames by the processor 110. Additionally, the memory 130 may store data received externally, such as nickname information, stored by the processor 110 in another server or device. However, the present disclosure is not limited thereto, and the memory 130 may store various information for performing the method for detecting the multi-access account using the similarity between the nicknames according to some exemplary embodiments of the present disclosure.

According to some exemplary embodiments of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to some exemplary embodiments of the present disclosure may use an arbitrary type of known wired/wireless communication system. The network unit 150 may transmit and receive information processed by the processor 110, a user interface, and the like through communication with other terminals. For example, the network unit 150 may provide the user interface generated by the processor 110 to a client (e.g., a user terminal). In addition, the network unit 150 may receive an external input of a user applied to a client and transfer the external input to the processor 110. In this case, the processor 110 may process operations such as outputting, correcting, changing, adding, and the like of information provided through the user interface based on the external input of the user received from the network unit 150.

Specifically, for example, the network unit 150 may transmit and receive various information for performing the method for detecting the multi-access account using the similarity between the nicknames according to some exemplary embodiments of the present disclosure. For example, the network unit 150 may receive one or more nickname information stored in a database. Additionally, the network unit 150 may externally transmit some data generated in the process of performing the method for detecting the multi-access account using the similarity between the nicknames described below to be stored in the database. For example, the network unit 150 may transmit information on the similar nickname group determined according to some exemplary embodiments of the present disclosure to the outside.

Meanwhile, according to some exemplary embodiments of the present disclosure, the computing device 100 may include a server as a computing system that transmits and receives information through communication with the client. In this case, the client may be any type of terminal which may access the server. For example, the computing device 100 which is the server may receive a query from a user terminal and generate a single information processing result corresponding to the query. In this case, the computing device 100 which is the server may provide, to the user terminal, a user interface including the processing result. At this time, the user terminal may output the user interface received from the computing device 100 as the server, and receive or process information through interaction with the user.

In an additional exemplary embodiment, the computing device 100 may also include any type of terminal that receives data resources generated by an arbitrary server and performs additional information processing.

FIG. 2 is a diagram for describing a processor of acquiring a plurality of component information from a plurality of nickname information according to some exemplary embodiments of the present disclosure.

Hereinafter, an operation of the exemplary component acquisition unit 200 implemented by the processor 110 will be described with reference to FIG. 2.

According to some exemplary embodiments of the present disclosure, the component acquisition unit 200 may acquire a plurality of component information 20 from a plurality of nickname information 10 based on predetermined configuration unit information. The component information 20 may define existence or non-existence of a component included in the predetermined configuration unit information in corresponding nickname information.

The nickname information 10 may include various identification information. For example, the nickname information 10 may include a character ID. The nickname information may be a combination of various types of characters, symbols, and numbers. For example, the exemplary nickname information may be configured by a combination of English, Korean, and numbers.

The component information 20 may be acquired by analyzing the nickname information according to the predetermined configuration unit information. The exemplary predetermined configuration unit information may include basic units such as characters, symbols, and numbers which may constitute the nickname information 10 as components. For example, when the nickname information 10 may be configured by English, Korean, and numbers, the predetermined configuration unit information may include Korean vowels and consonants, English alphabet, Arabic numbers (or parts thereof) as components.

The component acquisition unit 200 may acquire the component information 20 indicating the component included in the nickname information among the predetermined configuration unit information. For example, the component information 20 may define existence or non-existence of the component included in the predetermined configuration unit information. In an exemplary embodiment, when the predetermined configuration unit information is Korean vowels and consonants, English alphabet, and Arabic numbers, an exemplary operation of the component acquisition unit 200 is described. When the nickname information 10 is ‘game ID’, the component acquisition unit 200 may acquire, as the component information 20, [symbol] and [symbol] which are the Korean vowels and consonants included in the predetermined configuration unit information. As another example, when the nickname information 10 is ‘character1q’, the component acquisition unit 200 may acquire, as the component information 20, [symbol] and [symbol] which are the Korean vowels and consonants, Arabic number ‘1’, and English alphabet ‘q’ included in the predetermined configuration unit information. The predetermined configuration unit information is configured as a basic unit to comparatively simplify a computation process for determining the similarity. However, the predetermined configuration unit information is not limited thereto, and the predetermined configuration unit information may be variously defined. Further, the component acquisition unit 200 may acquire the component information according to various schemes.

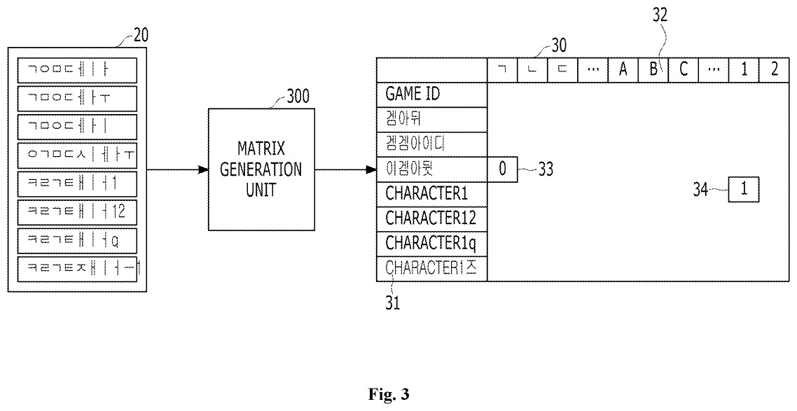

FIG. 3 is a diagram for describing a process of generating a nickname matrix using the plurality of component information according to some exemplary embodiments of the present disclosure.

Hereinafter, an operation of the exemplary matrix generation unit 300 implemented by the processor 110 will be described with reference to FIG. 3.

According to some exemplary embodiments of the present disclosure, the matrix generation unit 300 may generate a nickname matrix 30 using the plurality of component information. Here, the nickname matrix 30 may include a plurality of vector information corresponding to the plurality of component information 20, respectively.

In detail, when the plurality of component information 20 is acquired, the matrix generation unit 300 may generate a nickname matrix 30 that converts the plurality of component information into a type to easily determine the similarity. For example, the nickname matrix 30 may include a plurality of vector information corresponding to respective component information 31. When the component information 31 has a type indicating whether there is a component included in the nickname information among predetermined configuration unit information 32, the vector information may have a value 34 of ‘1’ with respect to the component included in the nickname information among the predetermined configuration unit information 32, and include a vector having a value 33 of ‘0’ with respect to a component not included in the nickname information among the predetermined configuration unit information 32. However, the present disclosure is not limited thereto, and the nickname matrix 30 may have various types which may determine the similarity between the nickname information.

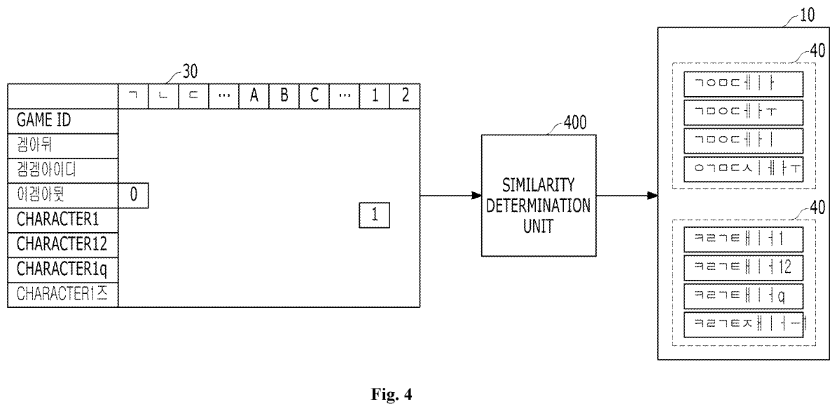

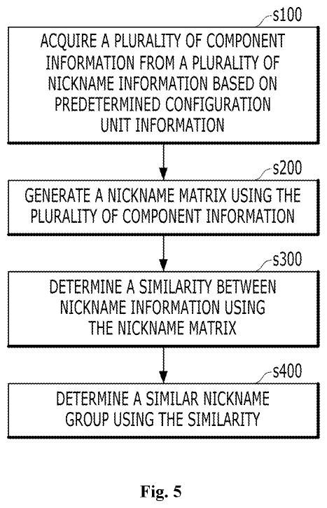

FIG. 4 is a diagram for describing a process of determining a similarity between nickname information using the nickname matrix 30 according to some exemplary embodiments of the present disclosure.

Hereinafter, an operation of the exemplary similarity determination unit 400 implemented by the processor 110 will be described with reference to FIG. 4.

According to some exemplary embodiments of the present disclosure, the similarity determination unit 400 may determine the similarity between the nickname information using the nickname matrix 30. In addition, the similarity determination unit 400 may determine a similar nickname group 40 using the similarity. Here, the similarity may be determined by a Jaccard Distance between two vector information corresponding to two nickname information.

In detail, when the nickname matrix 30 having the vector information for the nickname information is generated, the similarity determination unit 400 may compute a similarity between a plurality of nickname information in order to determine the similar nickname group 40 among the plurality of nickname information 10. For example, the similarity between two vector information among the plurality of vector information included in the nickname matrix 30 is determined, so a similarity between all or some nickname information may be determined. Here, the similarity may be determined by the Jaccard Distance (or may be referred to as Jaccard Coefficient, Jaccard Index, etc.) between two vector information. The Jaccard Distance may be determined by dividing an interaction of two sets by a union of two sets as in the following equation.

$$J ( A , B ) = \frac{\vert A ⋂ B \vert}{\vert A ⋃ B \vert} = \frac{\vert A ⋂ B \vert}{\vert A \vert + \vert B \vert - \vert A ⋂ B \vert} \qquad [ Equation 1 ]$$

The Jaccard Distance may have a value between 0 and 1, and may have a characteristic in that the Jaccard Distance has a higher value as two sets are similar and has a lower value as two sets are dissimilar. The similarity determination unit 400 may determine the similar nickname group 40 by grouping nickname information in which the Jaccard Distance is larger than a predetermined threshold value. However, the present disclosure is not limited thereto, and the similarity determination unit 400 may determine the similarity and the similar nickname group by various schemes.

When the similar nickname group 40 is determined, the nickname information included in the similar nickname group 40 is listed to be used for determining whether each nickname information is related to the multi-access account. According to some exemplary embodiments of the present disclosure, the similar nickname group 40 which may be related to the multi-access account may be quickly determined, and a target which passes through a process of determining a sanction target corresponding to the workplace account is limited to the nickname information included in the similar nickname group 40, so a time and resources required in the process of finding the workplace account may be remarkably reduced.

FIG. 5 is a flowchart of a method for detecting a multi-access account using a similarity between nicknames according to some exemplary embodiment of the present disclosure.

According to some exemplary embodiments of the present disclosure, the method of the present disclosure may include a step s100 of acquiring a plurality of component information from a plurality of nickname information based on predetermined configuration unit information. Alternatively, the component information may define existence or non-existence of a component included in the predetermined configuration unit information in corresponding nickname information. Alternatively, the predetermined configuration unit information may include Korean vowels and consonants. Alternatively, the predetermined configuration unit information may include English alphabet. Alternatively, the predetermined configuration unit information may include Arabic numbers.

According to some exemplary embodiments of the present disclosure, the method of the present disclosure may include a step s200 of generating a nickname matrix using the plurality of component information. Here, the nickname matrix may include a plurality of vector information corresponding to the plurality of component information, respectively.

According to some exemplary embodiments of the present disclosure, the method of the present disclosure may include a step s300 of determining a similarity between nickname information using the nickname matrix. Here, the similarity may be determined by a Jaccard Distance between two vector information corresponding to two nickname information.

According to some exemplary embodiments of the present disclosure, the method of the present disclosure may include a step s400 of determining a similar nickname group using the similarity.

The steps according to some exemplary embodiments of the present disclosure described above are presented just for description, and some steps may be omitted or separate steps may be added. Further, the steps may be performed according to an arbitrary order.

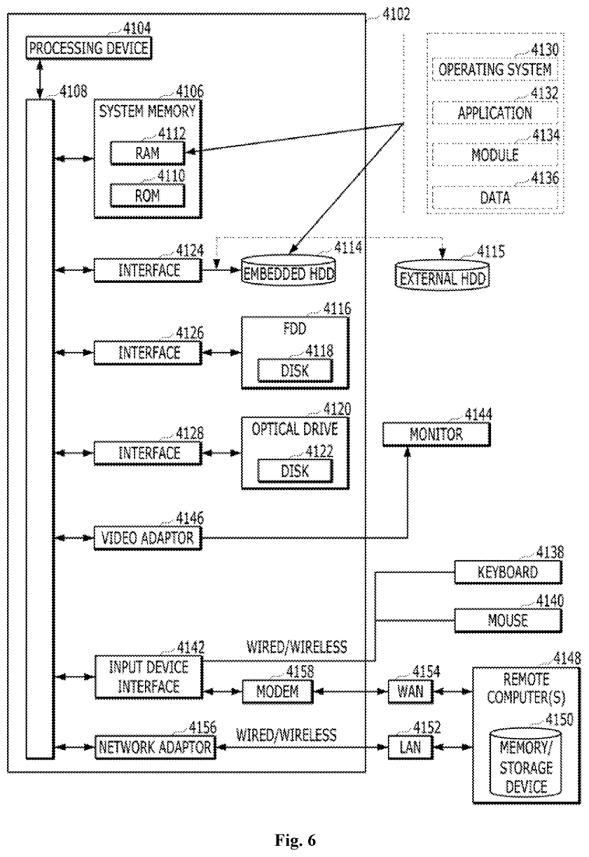

FIG. 6 is a simple and general schematic view of an exemplary computing environment in which exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least three devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

1. A method for detecting a multi-access account using a similarity between nicknames, which is performed by a computing device, the method comprising:
acquiring a plurality of component information from a plurality of nickname information based on predetermined configuration unit information;
generating a nickname matrix using the plurality of component information;
determining a similarity between nickname information using the nickname matrix; and
determining a similar nickname group using the similarity.

2. The method of claim 1, wherein the nickname matrix includes a plurality of vector information corresponding to the plurality of component information, respectively, and
the similarity is determined by a Jaccard Distance between two vector information corresponding to two nickname information.

3. The method of claim 1, wherein the component information defines existence or non-existence of a component included in the predetermined configuration unit information in the corresponding nickname information.

4. The method of claim 1, wherein the predetermined configuration unit information includes Korean vowels and consonants.

5. The method of claim 1, wherein the predetermined configuration unit information includes English alphabet.

6. The method of claim 1, wherein the predetermined configuration unit information includes Arabic numbers.

7. A computing device for performing a method of detecting a multi-access account using a similarity between nicknames, comprising:
a processor including at least one core; and
a memory including program codes executable in the processor,
wherein the processor is configured to
acquire a plurality of component information from a plurality of nickname information based on predetermined configuration unit information,
generate a nickname matrix using the plurality of component information,
determine a similarity between nickname information using the nickname matrix, and
determine a similar nickname group using the similarity.

8. A computer program stored in a computer-readable storage medium, wherein when the computer program is executed by one or more processors, the computer program allows one or more processors to perform operations for performing a method of detecting a multi-access account using a similarity between nicknames, and the method comprises:
acquiring a plurality of component information from a plurality of nickname information based on predetermined configuration unit information;
generating a nickname matrix using the plurality of component information;
determining a similarity between nickname information using the nickname matrix; and
determining a similar nickname group using the similarity.
